(19) United States
(12) Patent Application Publication
(10) Pub. No.: US 2022/0263957 A1
(43) Pub. Date: Aug. 18, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Shunichi KIMURA, Kanagawa (JP); Masanori SEKINO, Kanagawa (JP); Satoshi KUBOTA, Kanagawa (JP)

(73) Assignee: FUJIFILM Business Innovation Corp., Tokyo (JP)

(21) Appl. No.: 17/367,737

(22) Filed: Jul. 6, 2021

(30) Foreign Application Priority Data
Feb. 16, 2021 (JP) 2021-022762

(51) Int. Cl. H04N 1/00; G06K 9/03

(52) U.S. Cl. CPC H04N 1/00408; G06K 2209/01; G06K 9/033

(57) ABSTRACT

An information processing apparatus includes a processor configured to: display, on one screen, information written or entered at multiple predetermined items and a read result of reading the information from the items such that which piece of the information and the read result is displayed is changeable on a per item basis; and perform a function of assisting a user to at least verify or correct the read result on the one screen.

### CROSS-REFERENCE TO RELATED APPLICATIONS

This application is based on and claims priority under 35 USC 119 from Japanese Patent Application No. 2021-022762 filed Feb. 16, 2021.

### BACKGROUND

### (i) Technical Field

The present disclosure relates to an information processing apparatus and non-transitory computer readable medium.

### (ii) Related Art

Japanese Unexamined Patent Application Publication No. 09-073515 discloses a character recognition apparatus that is free from involving the frequent movement of the gaze of a user in character recognition and operation complication accompanied by the gaze movement.

When information written or entered at a predetermined item is read through optical character recognition (OCR), the accuracy of the OCR is not necessarily 100%. A user typically performs at least one of verification or correction operation on the resulting data. As an amount of workload in the operations by the user increases, labor costs increase. The operations may be completed in a shorter time.

### SUMMARY

Aspects of non-limiting embodiments of the present disclosure relate to providing a function of assisting a user to verify and/or correct results of reading information written or entered at a predetermined item.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: display, on one screen, information written or entered at multiple predetermined items and a read result of reading the information from the items such that which piece of the information and the read result is displayed is changeable on a per item basis; and perform a function of assisting a user to at least verify or correct the read result on the one screen.

### BRIEF DESCRIPTION OF THE DRAWINGS

Exemplary embodiments of the present disclosure will be described in detail based on the following figures, wherein:

FIG. 1 is a block diagram illustrating a hardware configuration of an information processing apparatus;

FIGS. 2A through 2C illustrate examples of documents serving as a read target in a first job;

FIGS. 3A through 3C illustrate examples of documents serving as a read target in a second job;

FIG. 4 illustrates tabular read results of image data included within read ranges of documents P1 through P3;

FIG. 5 illustrates tabular read results of image data included within read ranges of documents P4 through P6;

FIG. 6 is a flowchart illustrating a first execution process of the information processing apparatus;

FIGS. 7A and 7B illustrate a first display example displayed on a display of the information processing apparatus;

FIGS. 8A and 8B illustrate a second display example displayed on the display of the information processing apparatus;

FIGS. 9A and 9B illustrate a third display example displayed on the display of the information processing apparatus;

FIGS. 10A and 10B illustrate a fourth display example displayed on the display of the information processing apparatus;

FIGS. 11A through 11C illustrate a display method of document information displayed in an information display partition;

FIG. 12 is a flowchart illustrating a second execution process of the information processing apparatus;

FIG. 13 illustrates a fifth display example displayed on the display of the information processing apparatus;

FIGS. 14A and 14B illustrate a sixth display example displayed on the display of the information processing apparatus;

FIGS. 15A and 15B illustrate a display example on a verification screen of a first comparative example to a second exemplary embodiment;

FIGS. 16A and 16B illustrate a display example on a verification screen of a second comparative example to the second exemplary embodiment;

FIG. 17 illustrates a seventh display example displayed on the display of the information processing apparatus;

FIG. 18 is a flowchart illustrating a third execution process of the information processing apparatus;

FIGS. 19A through 19C illustrate an eighth display example displayed on the display of the information processing apparatus;

FIG. 20 illustrates a display example of a verification screen of a comparative example to a third exemplary embodiment;

FIG. 21 illustrates a document serving as a read target;

FIGS. 22A and 22B illustrate a ninth display example displayed on the display of the information processing apparatus;

FIG. 23 is a flowchart illustrating a fourth execution process of the information processing apparatus;

FIGS. 24A through 24C illustrate a tenth display example displayed on the display of the information processing apparatus; and

FIGS. 25A through 25C illustrate an eleventh display example displayed on the display of the information processing apparatus.

### DETAILED DESCRIPTION

### First Exemplary Embodiment

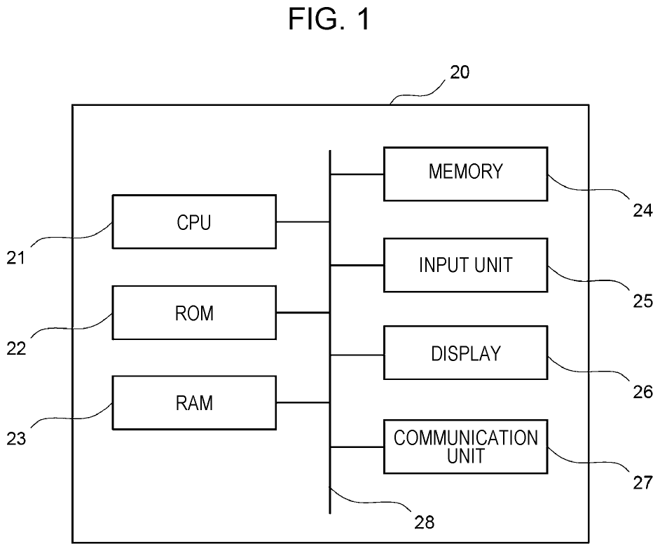

An information processing apparatus 20 of a first exemplary embodiment is described below. FIG. 1 is a block diagram illustrating a hardware configuration of the information processing apparatus 20. For example, the information processing apparatus 20 may be a general-purpose computer like a server computer or a personal computer, or a mobile terminal like a smart phone or a tablet terminal.

Referring to FIG. 1, the information processing apparatus 20 includes a central processing unit (CPU) 21, read-only memory (ROM) 22, random-access memory (RAM) 23, memory 24, input unit 25, display 26, and communication unit 27. These elements are mutually interconnected via a bus 28. The CPU 21 is an example of a processor.

The CPU 21 executes a variety of programs and controls the elements. The CPU 21 reads a program from the ROM 22 or the memory 24 and executes the read program using the RAM 23 as a working area. In accordance with the program stored on the ROM 22 or the memory 24, the CPU 21 controls the elements and performs a variety of arithmetic operations. According to the first exemplary embodiment, the ROM 22 or the memory 24 stores an information processing program that performs at least one of a first execution process, a second execution process, a third execution process, and a fourth execution process. The information processing program may be pre-installed on the information processing apparatus 20, or appropriately installed on the information processing apparatus 20 by storing the information processing program on a non-volatile recording medium or by delivering the information processing program via a network. The examples of the non-volatile recording medium may include a compact disk read-only memory (CD-ROM), magneto-optical disk, hard-disk drive (HDD), digital versatile disc ROM (DVD-ROM), flash memory, and memory card.

The ROM 22 stores a variety of programs and a variety of data. The RAM 23 works as a working area and temporarily stores a program or data.

The memory 24 includes the HDD, solid-state drive (SSD), or flash memory, and stores the variety of programs including an operating system and the variety of data.

The input unit 25 includes a pointing device, such as a mouse, a variety of buttons, keyboard, microphone, camera or the like and receives a variety of inputs.

The display 26 is, for example, a liquid-crystal display and displays a variety of information. The display 26 may be a touch panel and serve as the input unit 25.

The communication unit 27 is an interface used to communicate with another device. The communication may comply with wired communication standards, such as Ethernet (registered trademark) or fiber distributed data interface (FDDI) or wireless communication standards, such as 4G, 5G, Wi-Fi (registered trademark).

When the information processing program is executed, the information processing apparatus 20 performs a process in accordance with the information processing program using the hardware resources described above.

An optical character recognition (OCR) process performed by the information processing apparatus 20 is described below. The following discussion assumes that a fax function or a scan function of an image forming apparatus (not illustrated) is used, thus multiple documents including text, such as characters and symbols, written or entered at multiple predetermined items are digitized into image data, and the image data is usable through the OCR operation.

A read range within which image data of a document serving as a read target is read is set in the OCR process. In the OCR process, the image data included in the set read range is read and read results are displayed in text.

If a job serving as an execution unit in reading the image data included within the read range is performed, the image data within the read range in each of multiple pages (for example, 10 pages) of a document is read. According to the first exemplary embodiment, multiple read ranges used to read image data in each of multiple predetermined items are set on each document serving as the read target.

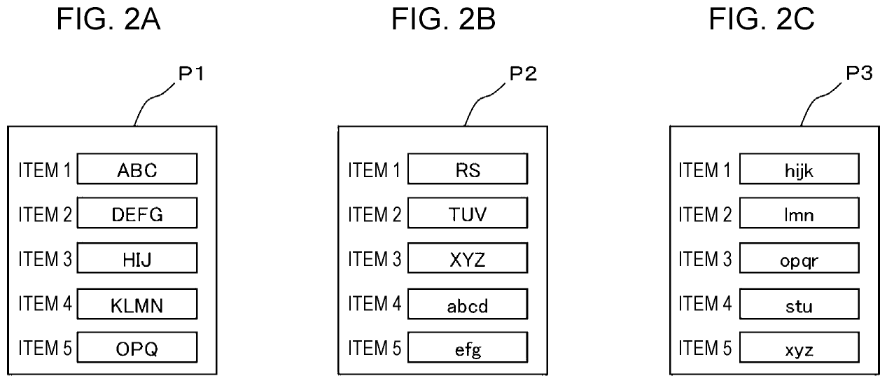

Examples of documents used in the first exemplary embodiment are illustrated. FIGS. 2A through 2C illustrate the examples of a read target in a first job. FIG. 2A illustrates a document P1 serving as a first-page read target in the first job, FIG. 2B illustrates a document P2 serving as a second-page read target in the first job, and FIG. 2C illustrates a document P3 serving as a tenth-page read target in the first job. The documents P1 through P3 are in a fixed format having the same document layout.

In the documents P1 through P3 as illustrated in FIGS. 2A through 2C, rectangular frames located to the right of labels “item 1,” “item 2,” “item 3,” “item 4,” and “item 5” are set as read ranges.

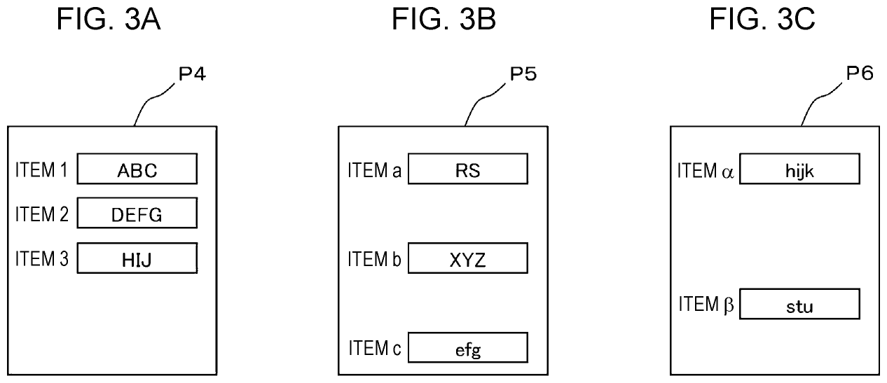

FIGS. 3A through 3C illustrate examples of documents serving as read targets in a second job. FIG. 3A illustrates a document P4 serving as a second-page read target in the second job, FIG. 3B illustrates a document P5 serving as a second-page read target in the second job, and FIG. 3C illustrates a document P6 serving as a third-page read target in the second job. The documents P4 through P6 are in a non-fixed format that is different from document to document.

Referring to FIG. 3A, rectangular frames located to the right of each of labels “item 1,” “item 2,” and “item 3” are set as read ranges. Referring to FIG. 3B, rectangular frames located to the right of each of labels “item a,” “item b,” and “item c” are set as read ranges. Referring to FIG. 3C, rectangular frames located to the right of each of labels “item α” and “item β” are set as read ranges.

The information processing apparatus 20 reads, in the OCR process, image data within each frame set as a read range regardless of whether layouts of documents included in a job are identical, and displays read results as text.

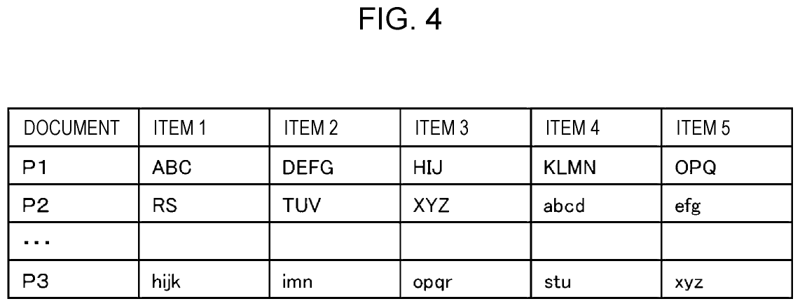

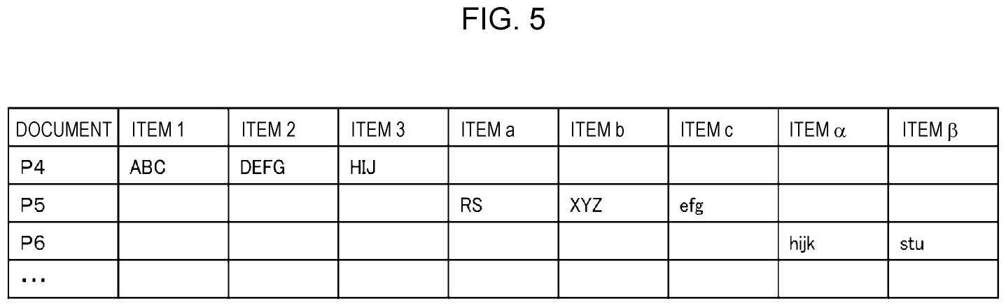

Examples of read results of the image data included in the read range in the OCR process are illustrated herein. FIG. 4 illustrates tabular read results of image data included within read ranges of the documents P1 through P3. FIG. 5 illustrates tabular read results of image data included within the read ranges of the documents P4 through P6. FIGS. 4 and 5 illustrate the read results that are obtained by associating each document in the job with each item in the document and reading the image data included in the read range corresponding to each item. The read results are displayed in text.

The match level at which the read results in the OCR process match the text written or entered beforehand on the document serving as the read target corresponding to the read results is not necessarily 100%. For this reason, a user may typically verify and/or correct the displayed read results (hereinafter this is referred to as “verification and correction job”). As an amount of the verification and correction job by the user increases, labor costs increase. The verification and correction job may be completed in a shorter period of time.

The information processing apparatus 20 of the first exemplary embodiment performs a first function as one of functions intended to assist a user to perform the verification and correction job on the read results in the OCR process.

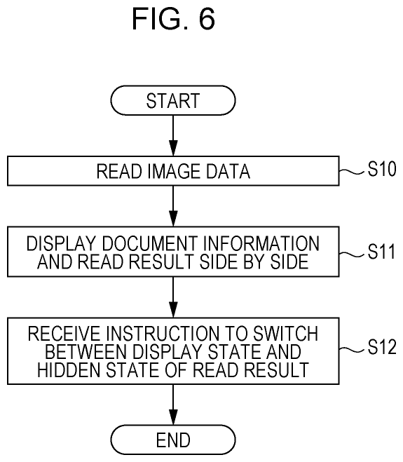

FIG. 6 is a flowchart illustrating a first execution process in which the information processing apparatus 20 performs the first function. The CPU 21 performs the first execution process by reading the information processing program from the ROM 22 or the memory 24 and expands the information processing program onto the RAM 23 for execution.

In step S10 in FIG. 6, the CPU 21 starts the OCR process and reads the image data included in each read range in multiple documents included in a single job. The CPU 21 then proceeds to step S11.

In step S11, the CPU 21 causes document information described below on each item of the documents and the read results of the image data on the document information to be displayed side by side on a verification screen 30 described below of the display 26. The CPU 21 then proceeds to step S12.

In step S12, the CPU 21 receives a switching operation from the user to switch a display status of the read results on the verification screen 30 between a display state with the read results displayed and a hidden state with the read results not displayed. The process thus ends. According to the first exemplary embodiment, multiple methods are available for the user to switch between the display state and the hidden state. The methods are described below.

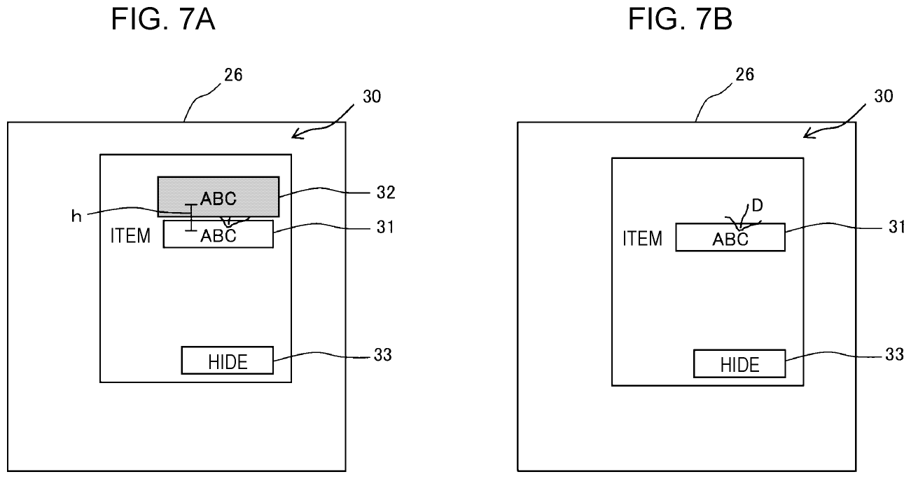

Display examples on the display 26 of the first exemplary embodiment are described. FIGS. 7A and 7B illustrate a first display example displayed on the display 26 of the information processing apparatus 20.

The display 26 in FIG. 7A illustrates the first display example of the verification screen 30 that is used for the user to verify the read results in the OCR process. As an example, the verification screen 30 is displayed in response to an operation on a mouse serving as the input unit 25 of the user. Specifically, the CPU 21 displays the verification screen 30 when a predetermined icon (not illustrated) to display the verification screen 30 on the display 26 is selected by left-clicking the predetermined icon. The verification screen 30 is displayed on the display 26 and is an example of “one screen”.

The verification screen 30 in FIG. 7A displays an information display partition 31, result display partition 32, and hide button 33.

The information display partition 31 on the verification screen 30 displays the document information that is written or entered at multiple predetermined items of a document serving as a read target.

The result display partition 32 on the verification screen 30 displays the read results of the image data of the document information included in the read range of the document serving as the read target.

According to the first exemplary embodiment, as illustrated in FIG. 7A, the CPU 21 causes the document information displayed within the frame of the information display partition 31 and the read results displayed in the frame of the result display partition 32 to be displayed side by side with one above the other. For example, the phrase “displayed side by side” signifies that a distance h between the document information and read result is equal to or shorter than the height of the rectangular frame of the information display partition 31 or the result display partition 32 or that the distance h between the document information and read result is equal to or shorter than the height of the text of the document information or the read results. According to the first exemplary embodiment, the phrase “displayed side by side” signifies that the distance h between the document information and read result is equal to or shorter than the height of the rectangular frame of the result display partition 32. When the hide button 33 is displayed with the verification screen 30 displayed in FIG. 7A, the CPU 21 switches the display status of the read results to a hidden state and deletes the result display partition 32 from the verification screen 30. The user is unable to view the read results in the hidden state in the first exemplary embodiment with the result display partition 32 deleted from the verification screen 30.

The display 26 in FIG. 7B displays a second display example of the verification screen 30. FIG. 7B illustrates a state of the verification screen 30 after the hide button 33 is operated with the verification screen 30 in FIG. 7A displayed.

With the result display partition 32 deleted from the verification screen 30 on the display 26 in FIG. 7B, the text “D” becomes visible as part of the document information that is not visible in FIG. 7A. Upon viewing the verification screen 30 in FIG. 7B, the user may learn that “D” has been included between “B” and “C” of the text written or entered beforehand in the document serving as the read target.

In the document serving as the read target in FIGS. 7A and 7B, “ABC” is written or entered once in the frame but an originally intended text is “ABDC” and thus “D” is later additionally written outside the frame. In such a case, if the document information and read result are displayed side by side, a portion added to the outside of the frame is covered with the result display partition 32 as illustrated in FIG. 7A and is thus invisible.

In the typical OCR process, the image data included in the frame set as the read range is read and converted into text data. A portion written or entered outside the frame may be typically not converted into text data. As a result, in a method in which the document information and read result are displayed side by side with the read results remaining displayed (hereinafter referred to as a first comparative arrangement), a portion added outside the frame in the verification and correction job of the user may be overlooked. In the first comparative arrangement, the user may find out the portion added outside the frame after completing the verification and correction job and thus may be obliged to perform the verification and correction job again.

According to the first exemplary embodiment, the CPU 21 causes the document information written or entered at multiple predetermined items of a document serving as a read target and the read results of the image data on the document information included in the read range to be displayed in a manner such that which piece of the document information and read result is displayed on the verification screen 30 is changeable on a per item basis of the document. The CPU 21 performs a first function that causes the document information and read result to be displayed side by side and receives the switching operation from the user to switch between a display state with the read result displayed and a hidden state with the read result not displayed. The operation “written or entered at the items” refers to not only an operation to write or enter data within the frame of the item but also an operation to write or enter data outside the frame corresponding to the item (see FIG. 7B).

As described above, the first exemplary embodiment provides a function of assisting the user to perform the verification and correction job on the read result. According to the first exemplary embodiment, when the first function is performed, whether to display the read result adjacent to the document information on the verification screen 30 is switched. Also, according to the first exemplary embodiment, the user may verify a portion outside the frame corresponding to the item of the document by switching the read result to the hidden state. In comparison with the first comparative arrangement, overlooking of the document information on the document may be controlled. Furthermore, according to the first exemplary embodiment, since the document information and read result are displayed side by side, the document information and read result are easily compared with each other. In comparison with the first comparative arrangement, the number of operation steps in the verification and correction job of the user may be reduced.

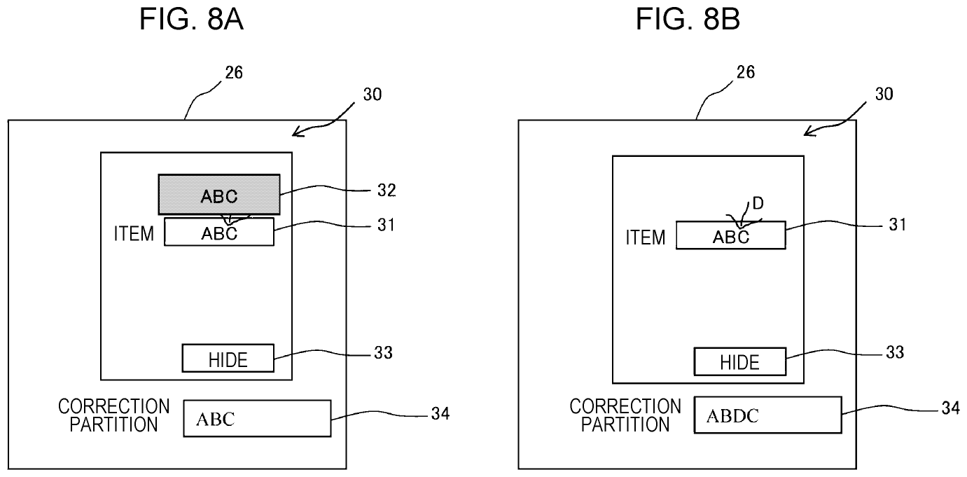

FIGS. 8A and 8B illustrate a second display example displayed on the display 26 of the information processing apparatus 20. The display 26 in FIG. 8A displays a third display example of the verification screen 30. The verification screen 30 in FIG. 8A includes the information display partition 31, result display partition 32, hide button 33, and correction partition 34. The document information displayed in the information display partition 31 and the read result displayed in the result display partition 32 illustrated in FIG. 8A are the same as those in FIG. 7A.

The correction partition 34 displays, in a manner ready to be corrected on the verification screen 30, a text that is the same as the read result displayed in the result display partition 32.

A function enabled to input a correction to the read result on the verification screen 30 is to be provided for the user to perform a correction operation to the read result in the verification and correction job. According to the first exemplary embodiment, the CPU 21 receives a user correction to the read result via the correction partition 34.

The display 26 in FIG. 8B displays a fourth display example of the verification screen 30. FIG. 8B illustrates a state of the verification screen 30 after the user has corrected the read result on the verification screen 30 in FIG. 8A using the correction partition 34.

The correction partition 34 in FIG. 8B illustrates the text “ABC” on the correction partition 34 in FIG. 8A with “D” added between “B” and “C.” The user may delete the result display partition 32 from the verification screen 30 using the hide button 33. Referring to FIG. 8B, the user may thus correct the read result using the correction partition 34 while viewing a portion of the document information that is invisible in FIG. 8A.

When the first function is performed as described above, the CPU 21 displays the correction partition 34 in addition to the document information and read result on the verification screen 30. According to the first exemplary embodiment, the text displayed as the document information and read result is not correctable but the text displayed in the correction partition 34 is correctable. The read result may thus be corrected using the correction partition 34. According to the first exemplary embodiment, the user may perform the verification and correction job on the read result while viewing the document information and read result displayed on the same screen.

The correction partition 34 may display beforehand the same text as the read result displayed in the result display partition 32 as illustrated in FIG. 8A or may be blank in a default state with no text displayed.

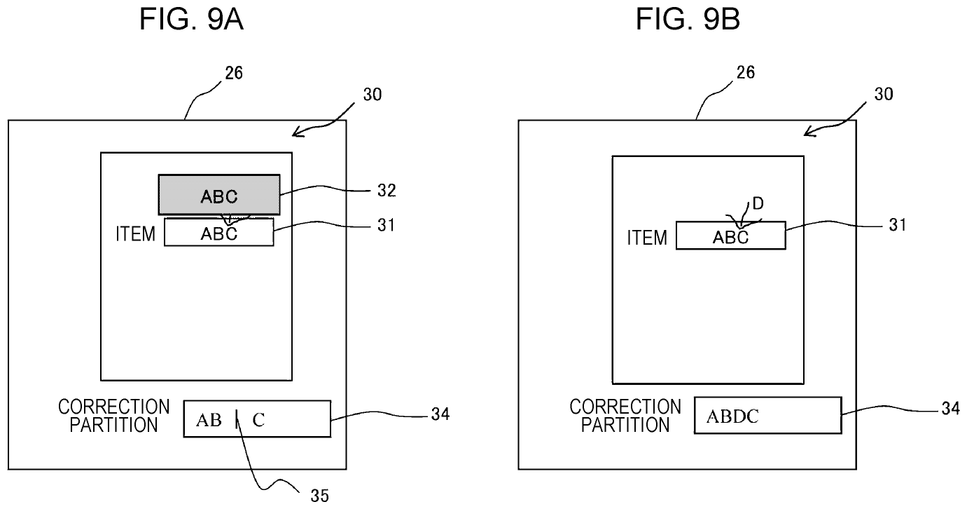

FIGS. 9A and 9B illustrate a third display example displayed on the display 26 of the information processing apparatus 20. The display 26 in FIG. 9A displays a fifth display example of the verification screen 30. The verification screen 30 illustrated in FIG. 9A includes the information display partition 31, result display partition 32, and correction partition 34. The document information displayed in the information display partition 31 and the read result displayed in the result display partition 32 in FIG. 9A are the same as those in FIG. 7A.

When a correction to the read result using the correction partition 34 is received with the verification screen 30 in FIG. 9A displayed, the CPU 21 switches the display status of the read result to the hidden state and deletes the result display partition 32 from the verification screen 30. For example, when a caret 35 is displayed in response to the left-clicking of the mouse on the text displayed in the correction partition 34, the CPU 21 deletes the result display partition 32 from the verification screen 30.

The display 26 in FIG. 9B displays a sixth display example of the verification screen 30. FIG. 9B illustrates a state of the verification screen 30 after a correction to the read result is performed on the verification screen 30 in FIG. 9A by the user using the correction partition 34.

The correction partition 34 in FIG. 9B illustrates the text “ABC” on the correction partition 34 in FIG. 9A with “D” added between “B” and “C.” The addition of “D” is performed when the user performs a character key operation on a keyboard as the input unit 25. Unlike the verification screen 30 in FIGS. 8A and 8B, the result display partition 32 is deleted from the verification screen 30 in FIG. 9B without the user operating the hide button 33. On the verification screen 30 in FIG. 9B, in response to the reception of the correction to the read result using the correction partition 34, the CPU 21 switches the read result to the hidden state and deletes the result display partition 32 from the verification screen 30. In comparison with the arrangement in which the instruction to switch the read result to the hidden state is different from an instruction to receive the correction to the read result using the correction partition 34, the number of operation steps of the user in the verification and correction job is reduced in the first exemplary embodiment.

The correction to the read result using the correction partition 34 may be accepted by left-clicking the mouse on the text displayed in the correction partition 34. Alternatively, the correction to the read result using the correction partition 34 may also be accepted by left-clicking the mouse at any location within or on the frame of the correction partition 34.

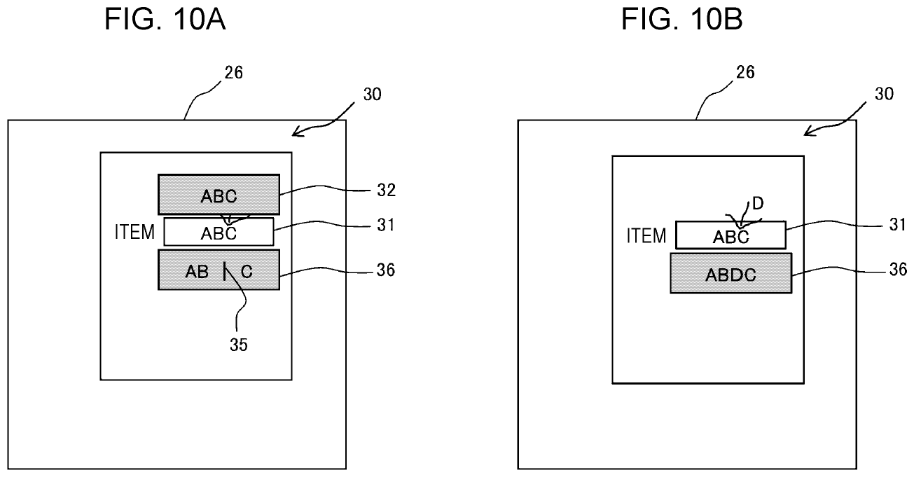

FIGS. 10A and 10B illustrate a fourth display example displayed on the display 26 of the information processing apparatus 20. The display 26 in FIG. 10A displays a seventh display example of the verification screen 30. The verification screen 30 in FIG. 10A includes the information display partition 31, and result display partitions 32 and 36.

The document information displayed in the information display partition 31 and the read result displayed in the result display partitions 32 and 36 in FIG. 10A are identical to those in FIG. 7A. Unlike the verification screen 30 in FIGS. 7A and 7B, a correction is possible on the verification screen 30 in FIGS. 10A and 10B by using the read results in the result display partitions 32 and 36.

Referring to FIG. 10A, the CPU 21 displays the document information in the information display partition 31 inserted between the read results in the result display partitions 32 and 36.

If a correction to one read result among multiple the read results displayed on the verification screen 30 in FIG. 10A, the CPU 21 switches the other read results than the one read result to the hidden state and deletes from the verification screen 30 the result display partition 32 or 36 with the other read results displayed therewithin. As an example, if the caret 35 is displayed with the mouse left-clicked on the read result in the result display partition 32 or 36, the CPU 21 deletes from the verification screen 30 the result display partition 32 or 36 with the read result without the caret 35.

The display 26 in FIG. 10B displays an eighth display example of the verification screen 30. FIG. 10B illustrates a state of the verification screen 30 after a correction to the read result is performed on the verification screen 30 in FIG. 10A by the user using the result display partition 36.

The result display partition 36 in FIG. 10B displays “ABC” in the correction partition 36 in FIG. 10A with the text “D” added between “B” and “C.” The addition of the text “D” is performed when the user performs a character key operation on a keyboard as the input unit 25. Since the result display partition 32 is deleted from the verification screen 30 in FIG. 10B, the user may correct the read result using the result display partition 36 while verifying that “D” is inserted between the text “B” and “C” written or entered beforehand on the document serving as the read target. As described above, the read result displayed in the result display partition 36 is an example of a “first read result” and the read result displayed in the result display partition 32 is an example of a “second read result”.

As described above, if the first function is performed, the CPU 21 causes the multiple read results with the same contents and the document information corresponding to the read results to be displayed side by side on the verification screen 30. If a correction to the one of the read results is received on the displayed verification screen 30, the CPU 21 switches the other read results than the one read result to the hidden state. According to the first exemplary embodiment, the switching operation whether to display a portion of the read results displayed side by side on the verification screen 30 is performed. According to the first exemplary embodiment, since the user may verify an portion outside the frame corresponding to an item of the document serving as the read target by causing the read result other than the correction target to be invisible to the user, overlooking of the document information of the document may be controlled in comparison with the first comparative arrangement.

The display method of the document information displayed in the information display partition 31 of the first exemplary embodiment is described below.

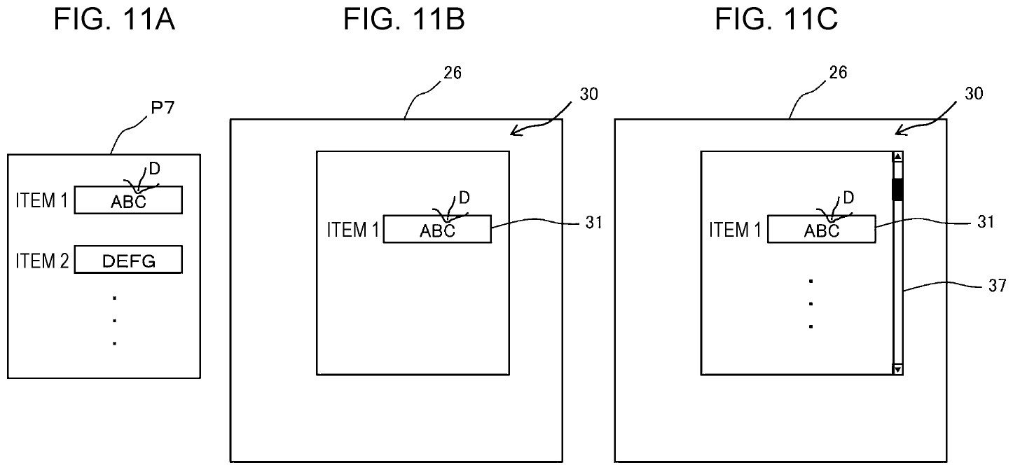

FIGS. 11A through 11C illustrate the display method of the document information displayed in the information display partition 31 in accordance with the first exemplary embodiment.

FIG. 11A illustrates a document P7 serving as a read target. Referring to FIG. 11A, texts are written or entered beforehand at multiple items, such as an “item 1” and “item 2” in the document P7.

FIG. 11B illustrates a first display method on the information display partition 31 of the document information corresponding to each item in the document P7 in FIG. 11A. In the first display method, the CPU 21 cuts out and displays a region including the text written or entered beforehand at one item of the document P7. If a predetermined icon (not illustrated) used to display the next item on the display 26 is selected by left-clicking, the CPU 21 cuts out and display a region including the text written or entered beforehand at the next item of the document P7.

FIG. 11C illustrates a second display method of the information display partition 31 of the document information corresponding to each item of the document P7 in FIG. 11A. The second display method is identical to the first display method in that part of the document P7 is displayed but different from the first display method in how the text written or entered beforehand at the next item is displayed. Specifically, in the second display method, the region of the document P7 the CPU 21 displays in the information display partition 31 is shifted by scrolling the screen using a scroll bar 37.

According to the first exemplary embodiment, the document information and read result are displayed side by side with one above the other on the verification screen 30. The manner of displaying the document information and read result is not limited to this vertically stacked arrangement. The document information and read result may be displayed laterally side by side.

According to the first exemplary embodiment, two read results are displayed on the verification screen 30. Alternatively, the number of read results to be displayed on the verification screen 30 may be 3 or more.

### Second Exemplary Embodiment

A second exemplary embodiment of the information processing apparatus 20 is described. A portion of the second exemplary embodiment common to the first exemplary embodiment is briefly described or not described at all.

The information processing apparatus 20 of the second exemplary embodiment performs a second function as described below as a function of assisting the user to perform the verification and correction job on the read result in the OCR process.

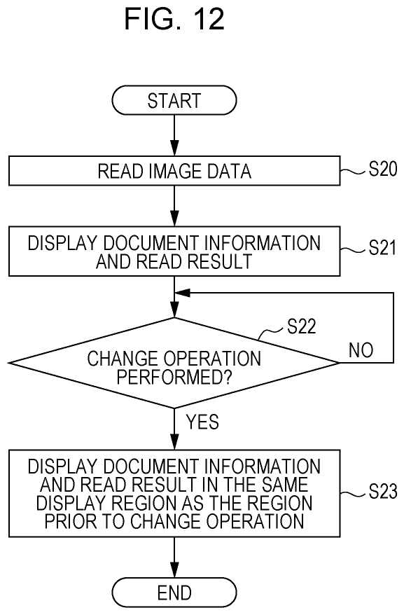

FIG. 12 is a flowchart illustrating a second execution process in which the information processing apparatus 20 performs the second function. The CPU 21 performs the second execution process by reading the information processing program from the ROM 22 or the memory 24 and loading the information processing program onto the RAM 23 for execution.

In step S20 in FIG. 12, the CPU 21 starts the OCR process and reads the image data included in each read range of multiple documents included in a job. The CPU 21 then proceeds to step S21.

In step S21, the CPU 21 causes the document information at each item of the documents and the read result of the image data of the document information to be displayed on the verification screen 30 of the display 26. The CPU 21 then proceeds to step S22.

In step S22, the CPU 21 determines whether a change operation to change which piece of the document information and read result is displayed on the verification screen 30 has been performed via the input unit 25. If the CPU 21 determines that the change operation has been performed (yes path in step S22), the CPU 21 proceeds to step S23. On the other hand, if the CPU 21 determines that the change operation has not been performed (no path in step S22), the CPU 21 waits on standby until the change operation is performed. According to the second exemplary embodiment, the change operation is an operation of an enter key or a tab key on the keyboard as the input unit 25.

In step S23, the CPU 21 changes which piece of the document information and read result is displayed on the verification screen 30 and causes the document information and read result to be displayed in the same display region as the region prior to the change operation. The process thus ends.

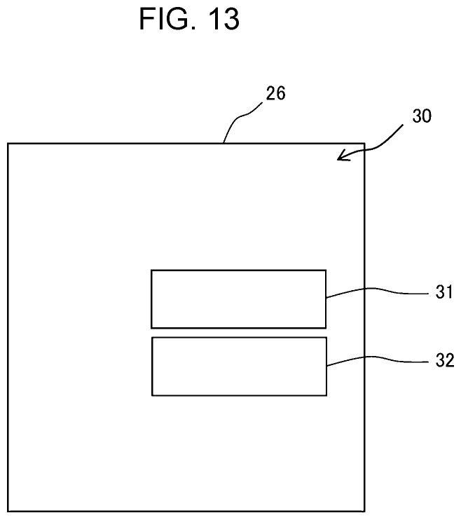

The display example of the display 26 of the second exemplary embodiment is described below. FIG. 13 displays a fifth display example displayed on the display 26 of the information processing apparatus 20.

A ninth display example of the verification screen 30 is displayed on the display 26 in FIG. 13. The information display partition 31 and result display partition 32 are displayed near the center of the screen of the display 26. The rectangular frame of each of the information display partition 31 and the result display partition 32 is displayed at a fixed location or in the same display region. The document information of the document serving as a read target is displayed in the frame of the information display partition 31 and the read result of the image data of the document information included in the read range of the document serving as the read target are displayed in the frame of the result display partition 32, although the document information and read result are not illustrated in FIG. 13.

According to the second exemplary embodiment, which piece of the document information and read result at each of the items of the document P1 in FIG. 2A is displayed is changed and displayed on a per item basis.

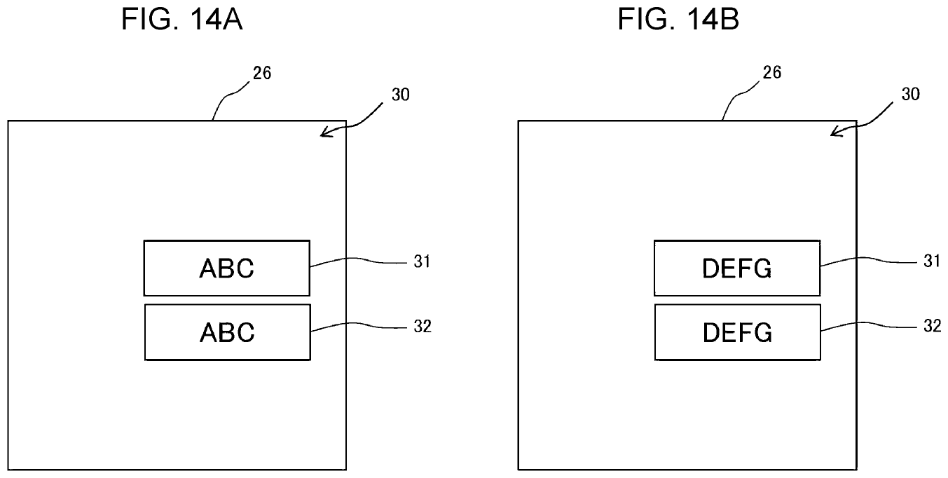

FIGS. 14A and 14B illustrates a sixth display example displayed on the display 26 of the information processing apparatus 20. FIG. 14A illustrates a tenth display example of the verification screen 30 where the document information and read result corresponding to the item 1 of the document P1 are displayed. FIG. 14B illustrates an eleventh display example of the verification screen 30 where the document information and read result corresponding to the item 2 of the document P1 are displayed.

When a predetermined icon (not illustrated) used to display the verification screen 30 on the display 26 is selected through left-clicking, the CPU 21 causes the verification screen 30 in FIG. 14A to be displayed. Specifically, the CPU 21 causes the text “ABC” corresponding to the item 1 of the document P1 to be displayed as the document information and read result in the information display partition 31 and result display partition 32. If the CPU 21 determines that the change operation has been performed with the verification screen 30 in FIG. 14A displayed, the CPU 21 changes the document information and read result displayed on the verification screen 30. Specifically, the CPU 21 causes a text “DEFG” corresponding to the item 2 of the document P1 as a result of change to be displayed as the document information and read result in the information display partition 31 and the result display partition 32 in the same display regions as those prior to the change. According to the second exemplary embodiment, in other words, since the display regions of the document information and read result are respectively fixed to within the frames of the information display partition 31 and the result display partition 32 near the center of the display 26, the document information and read result are displayed within the same frames as those prior to the change operation. According to the second exemplary embodiment, the document information and read results corresponding to multiple items of the document P1 are not displayed within the frames of the information display partition 31 and the result display partition 32 but the document information and read result corresponding to a single item are displayed within the frames of the information display partition 31 and the result display partition 32.

In order to reduce the number of operation steps in the verification and correction job on the read result by the user, the movement of the gaze of the user may be reduced in verifying the read result.

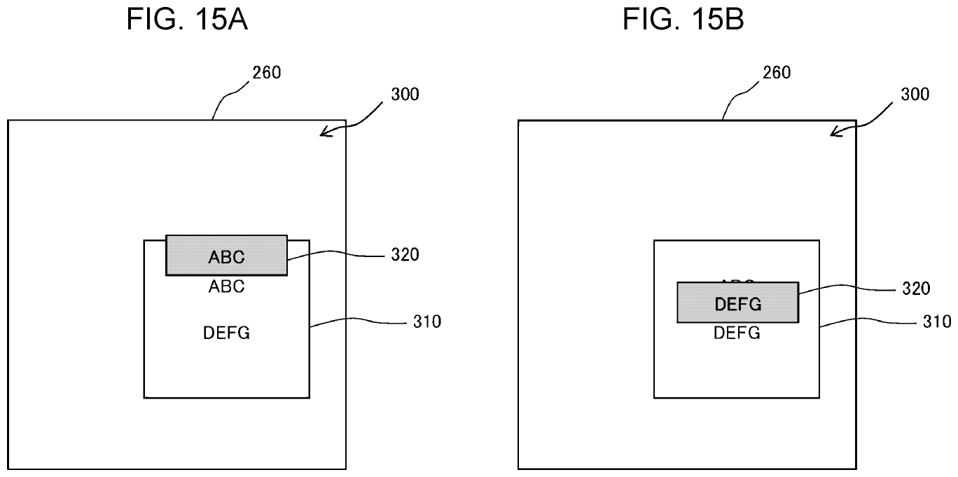

FIGS. 15A and 15B illustrate display examples of a verification screen 300 of a first comparative example to the second exemplary embodiment (hereinafter referred to as a second comparative arrangement). The verification screen 300 in FIGS. 15A and 15B includes an information display partition 310 and result display partition 320.

The information display partition 310 in FIGS. 15A and 15B displays text “ABC” for the item 1 and text “DEFG” for the item 2 of the document P1 as the document information, side by side with one text above the other text. The result display partition 320 displays the read result corresponding to a single item of the document P1.

In the second comparative arrangement, the text “ABC” as the document information and the text “ABC” as the read result are displayed side by side with one text above the other text as illustrated in FIG. 15A. In the second comparative arrangement, the text “DEFG” as the document information and the text “DEFG” as the read result are displayed side by side with one text above the other as illustrated in FIG. 15B.

In the second comparative arrangement, the gaze of the user vertically moves to verify multiple read results.

In contrast, according to the second exemplary embodiment, the CPU 21 performs the second function that causes the document information and read result to be displayed at the information display partition 31 and the result display partition 32 as the same display regions as display regions prior to the change of the document information and read result on the verification screen 30. According to the second exemplary embodiment, the movement of the gaze of the user in verifying the read result may be reduced in comparison with the arrangement in which the document information and read result are displayed in the display regions that are different from the display regions prior to the change.

A second comparative example to the second exemplary embodiment (hereinafter referred to as a third comparative arrangement) is described below.

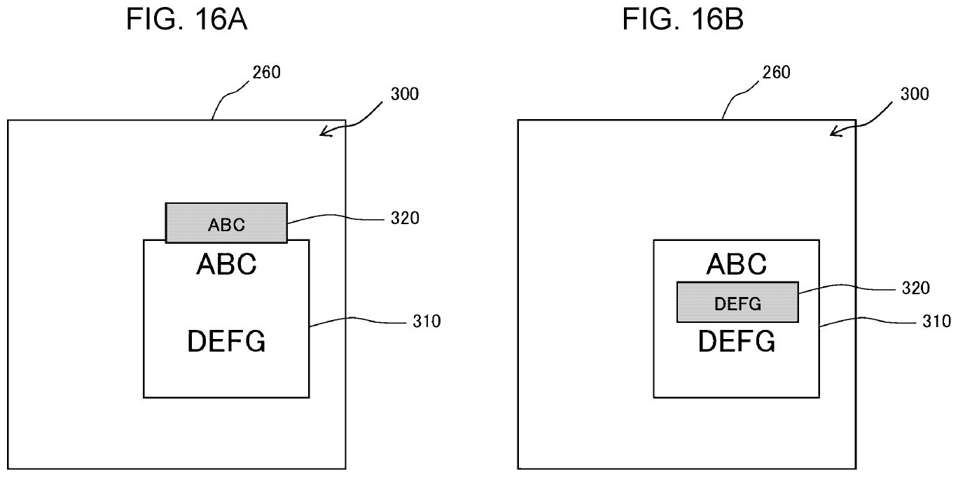

FIGS. 16A and 16B illustrate a display example of the verification screen 300 in accordance with the third comparative arrangement. The verification screen 300 in FIGS. 16A and 16B includes the information display partition 310 and the result display partition 320. The document information displayed in the information display partition 310 and the read result displayed in the result display partition 320 are the same as those in FIGS. 15A and 15B.

Referring to FIG. 16A, “ABC” displayed as the document information is larger in display size than “ABC” displayed as the read result in the third comparative arrangement and the document information and read result are thus different in display size. In the third comparative arrangement as well, referring to FIG. 16B, “DEFG” displayed as the document information is larger in display size than “DEFG” displayed as the read result and the document information and read result are thus different in display size.

In the third comparative arrangement, the user has difficulty in focusing concurrently on the text displayed as the document information and the text displayed as the read result. In the third comparative arrangement, for example, the user may focus first on the text displayed as the read result and then moves the gaze to the text displayed as the document information for focusing. In the third comparative arrangement, the gaze movement of the user in comparing the document information with the read result may be expected to increase.

According to the second exemplary embodiment, in contrast, if the second function is performed, the CPU 21 displays the document information and read result in substantially equal size.

According to the second exemplary embodiment, display sizes of the height and width of a single text of the document information and the height of the frame of the information display partition 31 and result display partition 32 are set beforehand and stored on the memory 24. According to the second exemplary embodiment, three types of methods are available as described below to set the document information and read result to substantially equal display sizes.

A first method utilizes a presence range W and the number of texts N of the document information displayed in the information display partition 31. Referring to FIG. 14A, the presence range W is a width from the left end of “A” to the right end of “C” displayed as the document information and the number of text N is “3.” For example, if the presence range W is 3 cm, the width per text of the document information is calculated by dividing the presence range W by the number of texts N. In this case, the width per text of the document information is “1 cm.” The CPU 21 retrieves the display size corresponding to the width per text “1 cm” from the memory 24 and displays the read result in the retrieved display size.

A second method utilizes the height of one text of the document information displayed in the information display partition 31. In the second method, as illustrated in FIG. 14A, the CPU 21 calculates the mean value of the heights of “A,” “B,” and “C” displayed as the document information, retrieves the display size corresponding to the calculated mean value of heights from the memory 24, and displays the read result in the retrieved display size.

A third method utilizes the height of the frame of the information display partition 31 and result display partition 32. In the third method, for example, as illustrated in FIG. 14A, the CPU 21 calculates the mean value of the heights of the frames of the information display partition 31 and result display partition 32, retrieves the display size corresponding to the mean value of heights from the memory 24, and displays the read result in the retrieved display size.

As described above, according to the second exemplary embodiment, the user may focus concurrently on the text displayed as the document information and the text displayed as the read result. According to the second exemplary embodiment, the movement of the gaze of the user in verifying the read result may be smaller than when the document information and read result are different in display size.

The substantially equal display size does not necessarily signify the same display size and a slight degree of difference in display size is acceptable. For example, if the display size of the document information does not match the display size of the predetermined read result, the CPU 21 causes the read result to be displayed at a display size closest to the display size of the document information. In this case, as well, the document information and read result are considered to be displayed in the substantially equal display size.

If the display size of the document information and read result is smaller than a first predetermined size, the CPU 21 causes to be displayed the document information, the read result, and the correction partition 34 that is used to accept a correction to the read result from the user. The CPU 21 causes a correction display having the same text as the read result displayed in the correction partition 34 to be displayed at a second size larger than the first size on the verification screen 30.

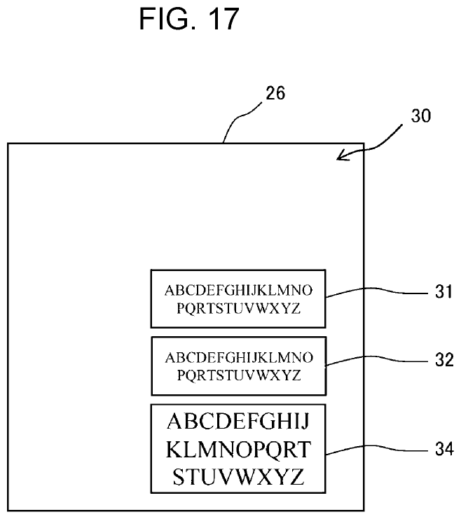

FIG. 17 illustrates a seventh display example displayed on the display 26 of the information processing apparatus 20. The display 26 in FIG. 17 displays a twelfth display example of the verification screen 30. The verification screen 30 in FIG. 17 includes the information display partition 31, result display partition 32, and correction partition 34.

As illustrated in FIG. 17, the information display partition 31 displays a text “ABCDEFGHIJKLMNOPQRTSTUVWXYZ” as the document information and the result display partition 32 displays a text “ABCDEFGHIJKLMNOPQRTSTUVWXYZ” as the read result.

The correction partition 34 in FIG. 17 displays, as the correction display, “ABCDEFGHIJKLMNOPQRTSTUVWXYZ” that is the same as the read result, in a correctable manner.

Since the display size of the document information and read result in FIG. 17 is smaller than the first size, the CPU 21 causes the correction partition 34 in addition to the document information and read result to be displayed on the verification screen 30 and causes the correction display to be displayed at the second size larger than the first size on the correction partition 34. The second size is a fixed display size that is set beforehand and has higher visibility to the user.

In the arrangement described above, according to the second exemplary embodiment, visibility to the user who verifies the read result may be increased to be higher than when only the text at a size smaller than the first predetermined size is displayed on the verification screen 30.

According to the second exemplary embodiment, the change operation is performed by an operation of the enter key or tab key on the keyboard as the input unit 25. The disclosure is not limited to the operation performed by the enter key or tab key. The change operation may be performed by an operation of a predetermined button displayed on the display 26, a mouse operation, or an operation of a key different from the enter key and tab key on the keyboard.

### Third Exemplary Embodiment

A third exemplary embodiment of the information processing apparatus 20 is described below. A portion of the third exemplary embodiment common to the other exemplary embodiments is briefly described or not described at all.

The information processing apparatus 20 of the third exemplary embodiment performs a third function as described below to assist the user to perform the verification and correction job on the read result in the OCR process.

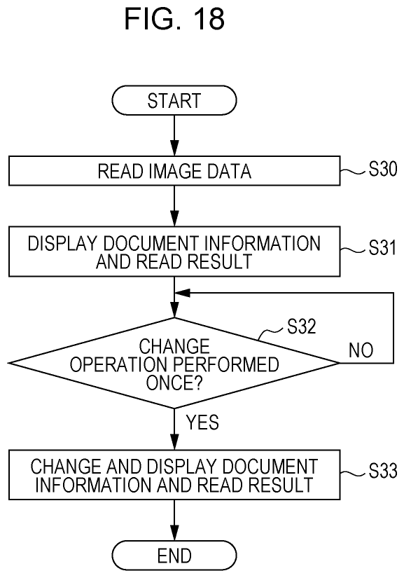

FIG. 18 is a flowchart illustrating a third execution process in which the information processing apparatus 20 performs the third function. The third execution process is performed when the CPU 21 reads the information processing program from the ROM 22 or the memory 24 and loads the information processing program onto the RAM 23 for execution.

In step S30 in FIG. 18, the CPU 21 starts the OCR process and reads the image data included in each read range of multiple documents in a single job. The CPU 21 proceeds to step S31.

In step S31, the CPU 21 causes the document information at each item of the document and the read result of the image data of the document information to be displayed on the verification screen 30 of the display 26. The CPU 21 then proceeds to step S32.

In step S32, the CPU 21 determines whether a change operation to change which piece of the document information and read result is displayed on the verification screen 30 is performed once via the input unit 25. If the CPU 21 determines that the change operation is performed once (yes path in step S32), the CPU 21 proceeds to step S33. On the other hand, if the CPU 21 determines that the change operation is not performed (no path in step S32), the CPU 21 waits on standby until the change operation is performed once. For example, as in the second exemplary embodiment, the change operation is performed by an operation on the enter key or tab key on the keyboard as the input unit 25.

In step S33, the CPU 21 changes which piece of the document information and read result is displayed and causes the next piece of document information and read result to be displayed on the verification screen 30. The process thus ends.

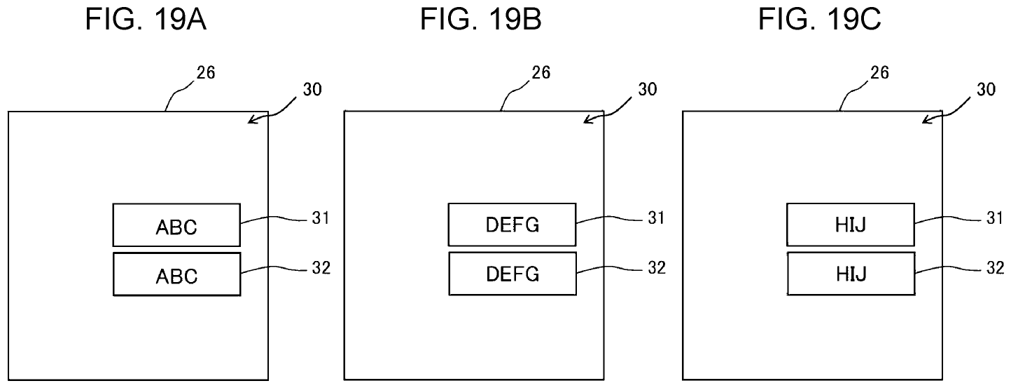

The display example of the display 26 of the third exemplary embodiment is described below. FIGS. 19A through 19C illustrate an eighth display example displayed on the display 26 of the information processing apparatus 20.

The display 26 in FIG. 19A displays a thirteenth display example of the verification screen 30. The verification screen 30 in FIG. 19A includes the information display partition 31 and result display partition 32. The information display partition 31 and result display partition 32 in FIG. 19A display the text “ABC” corresponding to the item 1 of the document P1 in FIG. 2A as the document information and read result. If the CPU 21 determines that the change operation is performed once with the verification screen 30 in FIG. 19A displayed, the CPU 21 changes which piece of the document information and read result is displayed on the verification screen 30.

The display 26 in FIG. 19B displays a fourteenth display example of the verification screen 30. FIG. 19B illustrates a state of the verification screen 30 after the change operation is performed once with the verification screen 30 in FIG. 19A displayed. On the verification screen 30 in FIG. 19B, the CPU 21 causes to be displayed the text “DEFG” corresponding to the item 2 of the document P1 as the document information and read result in the information display partition 31 and result display partition 32. If the CPU 21 determines that the change operation is performed once with the verification screen 30 in FIG. 19B displayed, the CPU 21 changes which piece of the document information and read result is displayed on the verification screen 30.

The display 26 in FIG. 19C displays a fifteenth display example of the verification screen 30. FIG. 19C illustrates a state of the verification screen 30 after the change operation is performed once with the verification screen 30 in FIG. 19B displayed. On the verification screen 30 in FIG. 19C, the CPU 21 causes to be displayed the text “HIJ” corresponding to the item 3 of the document P1 as the document information and read result in the information display partition 31 and result display partition 32.

The changing of the read result may be sped up in order to reduce the number of operation steps in the verification and correction job of the user on the read result.

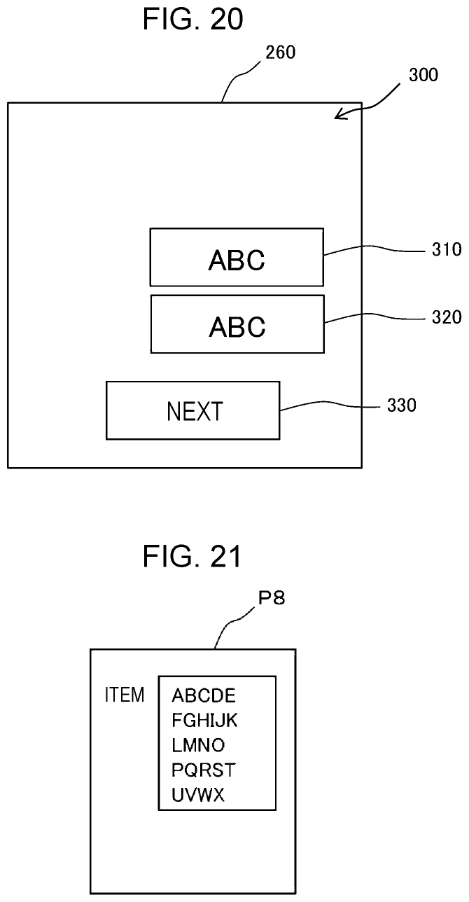

FIG. 20 illustrates a display example of the verification screen 300 as a comparative example to the third exemplary embodiment (hereinafter referred to as a fourth comparative arrangement). The verification screen 300 in FIG. 20 includes an information display partition 310, result display partition 320, and next button 330. The information display partition 310 and result display partition 320 in FIG. 20 display the text “ABC” corresponding to the item 1 of the document P1 in FIG. 2A as the document information and read result.

In the fourth comparative arrangement, if the user left-clicks the mouse after the user moves a mouse pointer onto the next button 330 with the verification screen 300 in FIG. 20 displayed, the document information and read result displayed on the verification screen 300 are changed.

The mouse operation is to be performed in the fourth comparative arrangement in which the document information and read result displayed are changed in response to the operation of the button displayed on a display 260. It is typically known that a mouse operation takes more time than a keyboard operation.

The accuracy of the OCR process has recently increased and the possibility that a read result matches a text written or entered beforehand on a document serving as a read target, namely, the possibility that the read result is correct has increased. If the read result is correct, a minimum amount of operation may be used to change to the next piece of document information and read result.

According to the third exemplary embodiment, if the CPU 21 receives the operation of the enter key or tab key once as the change operation, the third function to change which piece of the document information and read result is displayed on the verification screen 30 is performed. If the read result is correct, a single keyboard operation completes two job steps including “verifying that the read result is correct” and “changing to the next piece of document information and read result.” According to the third exemplary embodiment, the number of operation steps in the user verification and correction job on the read result may be reduced in comparison with the arrangement in which multiple steps of user operation is to be performed to change which piece of the document information and read result is displayed on the verification screen 30.

As the amount of image data, such as a text, included in the read range is smaller in the OCR process, the possibility of the correct read result is higher. Conversely, as the amount of image data, such as a text, included in the read range is larger in the OCR process, the possibility of the correct read result is lower. For this reason, if the text included in the read result is longer, an erroneous recognition of part of the text may occur and a single keyboard operation alone may have difficulty completing the two steps of job “verifying that the read result is correct” and “changing to the next piece of document information and read result.”

According to the third exemplary embodiment, if the change operation is received once when a portion of the piece of document information and read result at each item of the document serving as the read target is displayed on the verification screen 30, the CPU 21 performs the third function that displays another portion of the piece of document information and read result at each item of the document serving as the read target by changing which portion of the piece of document information and read result is displayed.

FIG. 21 illustrates a document P8 serving as a read target. Texts “ABCDE,” “FGHIJK,” “LMNO,” “PQRST,” and “UVWX” corresponding to a single item are written or entered beforehand line by line in the same frame in the document P8.

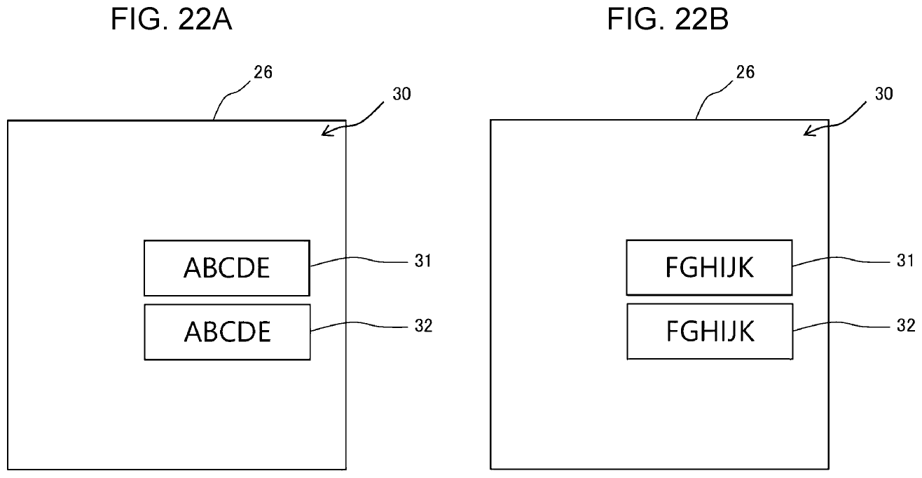

FIGS. 22A and 22B illustrate a ninth display example displayed on the display 26 of the information processing apparatus 20. The display 26 in FIG. 22A displays a sixteenth display example of the verification screen 30. The verification screen 30 in FIG. 22A includes the information display partition 31 and result display partition 32. The text “ABCDE” written or entered beforehand at the first row of the document P8 in FIG. 21 is displayed in the information display partition 31 and result display partition 32 in FIG. 22A. If the CPU 21 determines that the change operation is performed once with the information display partition 31 in FIG. 22A displayed, the CPU 21 changes which portion of the document information and read result is displayed on the verification screen 30.

The display 26 in FIG. 22B displays a seventeenth display example of the verification screen 30. FIG. 22B illustrates a state of the verification screen 30 after the change operation is performed once with the verification screen 30 in FIG. 22A displayed. On the verification screen 30 in FIG. 22B, the CPU 21 causes the text “FGHIJK” written or entered beforehand at the second row of the document P8 to be displayed as the document information and read result in the information display partition 31 and result display partition 32.

According to the third exemplary embodiment, the text written or entered beforehand in the same frame is segmented into multiple texts and the segmented texts are displayed as the document information and read result in the information display partition 31 and result display partition 32. If the text in the read result is longer in the third exemplary embodiment, a single keyboard operation thus completes the two steps of job “verifying that the read result is correct” and “changing to the next piece of document information and read result.” The number of operation steps in the user verification and correction job on the read result may be reduced in comparison with the arrangement in which the change operation to the document information and read result displayed on the verification screen 30 is performed on a per text basis within the read range.

According to the third exemplary embodiment, the text is segmented by row. The method of segmenting the text is not limited to this method. For example, the text may be segmented by N texts (for example, by three texts), or morpheme, word, phrase, or sentence. The analysis of the morpheme, word, phrase, and sentence may be performed using related art techniques.

According to the third exemplary embodiment, the change operation is performed by the operation of the enter key or tab key on the keyboard as the input unit 25. The disclosure is not limited to this key operation. The change operation may be a mouse operation or an operation of a key other than the enter key and tab key on the keyboard.

### Fourth Exemplary Embodiment

A fourth exemplary embodiment of the information processing apparatus 20 is described below. A portion of the fourth exemplary embodiment common to the other exemplary embodiments is briefly described or not described at all.

The information processing apparatus 20 of the fourth exemplary embodiment performs a fourth function to assist the user to perform the verification and correction job on the read result in the OCR process.

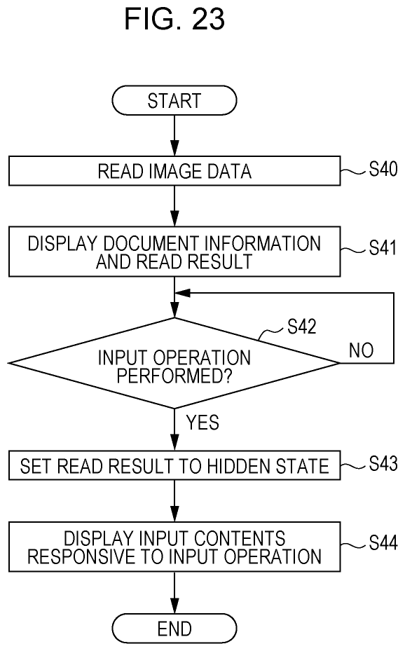

FIG. 23 is a flowchart illustrating a fourth execution process in which the information processing apparatus 20 performs a fourth function. The CPU 21 reads the information processing program from the ROM 22 or the memory 24 and loads the read information processing program onto the RAM 23 for execution.

In step S40 in FIG. 23, the CPU 21 starts the OCR process and reads the image data included in each read range of multiple documents included in a single job. The CPU 21 then proceeds to step S41.

In step S41, the CPU 21 causes the document information at each item of the document and the read result of the image data of the document information to be displayed on the verification screen 30 of the display 26. The CPU 21 then proceeds to step S42.

In step S42, the CPU 21 determines whether an input operation to correct the read result via the result display partition 32 is performed using the input unit 25. Upon determining that the input operation is performed (yes path in step S42), the CPU 21 proceeds to step S43. On the other hand, upon determining that no input operation is performed (no path in step S42), the CPU 21 waits on standby until an input operation is performed. For example, according to the fourth exemplary embodiment, the input operation is an operation on a character key or numerical key on the keyboard as the input unit 25.

In step S43, the CPU 21 switches the display status of the read result on the display 26 to the hidden state and deletes from the verification screen 30 the read result displayed in the result display partition 32. The CPU 21 then proceeds to step S44.

In step S44, the CPU 21 causes input contents to be displayed in the result display partition 32 in response to the input operation performed in step S42. The process thus ends.

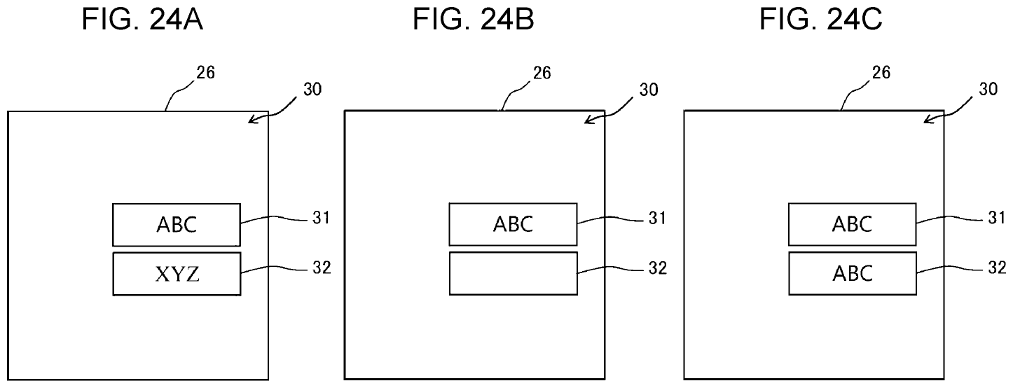

The display example on the display 26 according to the fourth exemplary embodiment is described below. FIGS. 24A through 24C illustrate a tenth display example displayed on the display 26 of the information processing apparatus 20.

The display 26 in FIG. 24A displays an eighteenth display example of the verification screen 30. The verification screen 30 in FIG. 24A includes the information display partition 31 and result display partition 32. The text “ABC” corresponding to the item 1 of the document P1 in FIG. 2A is displayed as the document information in the information display partition 31 in FIG. 24A. The text “XYZ” is displayed as the read result in the result display partition 32 in FIG. 24A in a manner such that the read result is correctable.

The text displayed as the document information does not match the text displayed as the read result on the verification screen 30 in FIG. 24A even by one character. If the CPU 21 determines that the input operation is performed with the verification screen 30 in FIG. 24A displayed, the CPU 21 switches the display status of the read result on the display 26 to the hidden state and deletes from the verification screen 30 the read result displayed in the result display partition 32. The hidden state of the fourth exemplary embodiment is that the user is unable to view the read result because the read result displayed in the result display partition 32 is deleted from the verification screen 30.

The display 26 in FIG. 24B displays a nineteenth display example of the verification screen 30. FIG. 24B illustrates a state of the verification screen 30 after the input operation is performed with the verification screen 30 in FIG. 24A displayed. On the verification screen 30 in FIG. 24B, the CPU 21 causes the result display partition 32 to be blank by deleting the read result displayed on the verification screen 30 in FIG. 24A.

The display 26 in FIG. 24C displays a twentieth display example of the verification screen 30. FIG. 24C illustrates a state of the verification screen 30 after contents responsive to the input operation are input to the result display partition 32 in FIG. 24B.

The result display partition 32 in FIG. 24C indicates input contents “ABC” that are responsive to the input operation and added to the frame of the result display partition 32 in FIG. 24B that has been blank. Since the text displayed as the document information matches the text displayed as the read result, the user verification and correction job on the read result is complete on the verification screen 30 in FIG. 24C.

The number of user operations to delete the read result displayed may be reduced in order to reduce the number of operation steps in the user the verification and correction job on the read result.

In an arrangement in which a delete key or backspace key on the keyboard is used to delete the displayed read result, a correction is to be input by operating a character key, numerical key, and the like after deleting the read result. If the read result fails to match the text written or entered beforehand onto the document serving as the read target corresponding to the read result, namely, the read result is in error, the number of operation steps in the verification and correction job increases in response to the deletion operation in comparison with the case in which the read result is correct.

According to the fourth exemplary embodiment, the CPU 21 performs the fourth function. In the fourth function, the CPU 21 sets the read result to the hidden state with no read result displayed if the input operation is received on the verification screen 30 and causes input contents responsive to the received input operation to be displayed in the result display partition 32 serving as a display region to display the read result. If the read result is in error, a single keyboard operation alone completes the two operation steps including “deleting all the read result” and “inputting contents responsive to the input operation.” According to the fourth exemplary embodiment, the number of operation steps in the user verification and correction job on the read result may be reduced in comparison with the arrangement in which the instruction to set the displayed read result to the hidden state is different from the instruction to display the input contents responsive to the input operation.

If the read result is in error and simply deleted, the number of operation steps in the verification and correction job may actually increase. For example, if an erroneous portion of the read result is one character, a correction may be more efficiently performed by using the read result.

According to the fourth exemplary embodiment, if the CPU 21 receives a particular operation different from the input operation, the fourth function is performed to set the read result to the display state on the verification screen 30 and receive from the user who uses the currently displayed read result. According to the fourth exemplary embodiment, the particular operation is performed by left-clicking the mouse as the input unit 25 on the read result displayed in the result display partition 32.

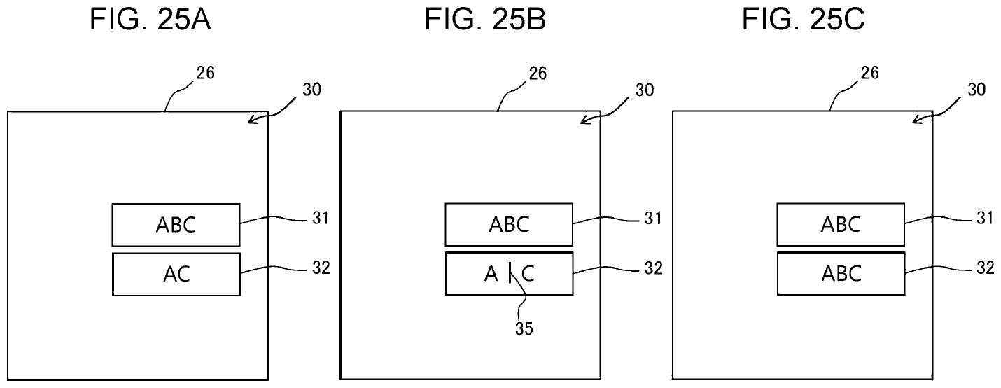

FIGS. 25A through 25C illustrate an eleventh display example displayed on the display 26 of the information processing apparatus 20. The display 26 in FIG. 25A displays a twenty-first display example of the verification screen 30. The verification screen 30 in FIG. 25A includes the information display partition 31 and result display partition 32. The information display partition 31 in FIG. 25A displays the text “ABC” corresponding to the item 1 of the document P1 in FIG. 2A. The result display partition 32 in FIG. 25A displays a text “AC” as the read result in a manner ready to be corrected.

The text displayed as the document information does not match the text displayed as the read result on the verification screen 30 in FIG. 25A and the difference therebetween is the lack of “B” as the text in the read result.

If the particular operation is received with the verification screen 30 in FIG. 25A displayed, the CPU 21 performs the fourth function to maintain the display status with the read result displayed on the verification screen 30 and receive a correction from the user who uses the displayed read result.

The display 26 in FIG. 25B illustrates a twenty-second display example of the verification screen 30. FIG. 25B illustrates a state of the verification screen 30 after the particular operation is performed with the verification screen 30 in FIG. 25A displayed. The verification screen 30 in FIG. 25B displays a caret 35 between “A” and “C” that are specified by left-clicking the mouse thereon. This signifies that a text may be added to the corresponding portion. When the input operation is received with the verification screen 30 in FIG. 25B displayed, the CPU 21 causes input contents responsive to the input operation to be displayed at the location indicated by the caret 35.

The display 26 in FIG. 25C displays a twenty-third display example of the verification screen 30. FIG. 25C illustrates a state of the verification screen 30 after the input operation is performed with the verification screen 30 in FIG. 25B displayed.

In the result display partition 32 in FIG. 25C, text “B” is entered between “A” and “C” that are displayed as “AC” in the result display partition 32 in FIG. 25B. Since the text displayed as the document information matches the text displayed as the read result, the user has completed the verification and correction job on the verification screen 30 in FIG. 25C.

As described above, according to the fourth exemplary embodiment, the number of operation steps in the user verification and correction job on the read result may be reduced in comparison with the arrangement in which the displayed read result is simply set to the hidden state in response to the operation of the user.

In the arrangement described above, the fourth exemplary embodiment may provide in combination a function of receiving the input with all the read result deleted and a function of receiving the correction using the displayed read result.

According to the fourth exemplary embodiment, the particular operation is the operation of left-clicking the mouse as the input unit 25 on the read result displayed in the result display partition 32. The particular operation is not limited to this operation. For example, the particular operation may be left-clicking the mouse at any location within or outside the result display partition 32 or an operation of any key not used to enter text, such as an arrow key on the keyboard.

### OTHER EXEMPLARY EMBODIMENTS

According to the embodiments, the verification screen 30 is displayed on the display 26 of the information processing apparatus 20. The terminal on which the verification screen 30 is displayed is not limited to the information processing apparatus 20. For example, the information processing apparatus 20 may perform at least one process selected from the group including the first through fourth execution processes and the verification screen 30 for the process result may be displayed on the display of one of apparatuses other than the information processing apparatus 20. Such apparatuses include a general-purpose computer, such as a server computer or a personal computer, and a mobile terminal, such as a smart phone or a tablet terminal.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
display, on one screen, information written or entered at a plurality of predetermined items and a read result of reading the information from the items such that which piece of the information and the read result is displayed is changeable on a per item basis; and
perform a function of assisting a user to at least verify or correct the read result on the one screen.

2. The information processing apparatus according to claim 1, wherein the function is a first function that displays the information and the read result side by side on the one screen and receives a switching operation from the user to switch between a display state with the read result displayed and a hidden state with the read result not displayed.

3. The information processing apparatus according to claim 2, wherein the processor is configured to, if the first function is performed, cause to be displayed on the one screen the information, the read result, and a correction partition that receives a correction to the read result from the user.

4. The information processing apparatus according to claim 3, wherein the processor is configured to, if the correction to the read result is received via the correction partition, switch the read result to the hidden state.

5. The information processing apparatus according to claim 2, wherein the processor is configured to:
if the first function is performed, cause to be displayed side by side on the one screen a plurality of read results displaying same contents and the information corresponding to the read results; and
if a correction to a first read result of the read results is received on the one screen, switch a second read result other than the first read result to the hidden state.

6. The information processing apparatus according to claim 3, wherein the processor is configured to:
if the first function is performed, cause to be displayed side by side on the one screen a plurality of read results displaying same contents and the information corresponding to the read results; and
if a correction to a first read result of the read results is received on the one screen, switch a second read result other than the first read result to the hidden state.

7. The information processing apparatus according to claim 4, wherein the processor is configured to:
if the first function is performed, cause to be displayed side by side on the one screen a plurality of read results displaying same contents and the information corresponding to the read results; and
if a correction to a first read result of the read results is received on the one screen, switch a second read result other than the first read result to the hidden state.

8. The information processing apparatus according to claim 1, wherein the function is a second function that causes the information and the read result to be displayed in same respective display regions on the one screen before and after changing which piece of the information and the read result is displayed.

9. The information processing apparatus according to claim 2, wherein the function is a second function that causes the information and the read result to be displayed in same respective display regions on the one screen before and after changing which piece of the information and the read result is displayed.

10. The information processing apparatus according to claim 3, wherein the function is a second function that causes the information and the read result to be displayed in same respective display regions on the one screen before and after changing which piece of the information and the read result is displayed.

11. The information processing apparatus according to claim 4, wherein the function is a second function that causes the information and the read result to be displayed in same respective display regions on the one screen before and after changing which piece of the information and the read result is displayed.

12. The information processing apparatus according to claim 5, wherein the function is a second function that causes the information and the read result to be displayed in same respective display regions on the one screen before and after changing which piece of the information and the read result is displayed.

13. The information processing apparatus according to claim 6, wherein the function is a second function that causes the information and the read result to be displayed in same respective display regions on the one screen before and after changing which piece of the information and the read result is displayed.

14. The information processing apparatus according to claim 8, wherein the processor is configured to, if the second function is performed, cause the information and the read result to be displayed in substantially equal display sizes.

15. The information processing apparatus according to claim 14, wherein the processor is configured to:
if a display size of the information and the read result is smaller than a first predetermined size, cause to be displayed the information, the read result, and a correction partition that receives a correction to the read result from the user; and
cause a correction display to be displayed in a second size larger than the first predetermined size in the correction partition on the one screen.

16. The information processing apparatus according to claim 1, wherein the function is a third function that, if a predetermined change operation is received once, changes which piece of the information and the read result is displayed on the one screen.

17. The information processing apparatus according to claim 16, wherein the processor is configured to, if the predetermined change operation is received once with a portion of the piece of the information and the read result displayed on a per item basis on the one screen, perform the third function that displays another portion of the piece of the information and the read result by changing which portion of the piece of the information and the read result is displayed on a per item basis.

18. The information processing apparatus according to claim 1, wherein the function is a fourth function that, if a predetermined input operation is received, sets the one screen to a hidden state with the read result not displayed and causes input contents responsive to the received predetermined input operation to be displayed in a display region used to display the read result on the one screen.

19. The information processing apparatus according to claim 18, wherein the processor is configured to, if a particular operation different from the predetermined input operation is received, perform the fourth operation that sets the one screen to a display state with the read result displayed and receive a correction from the user who has utilized the displayed read result.

20. A non-transitory computer readable medium storing a program causing a computer to execute a process, the process comprising:
displaying, on one screen, information written or entered at a plurality of predetermined items and a read result of reading the information from the items such that which piece of the information and the read result is displayed is changeable on a per item basis; and
performing a function of assisting a user to at least verify or correct the read result on the one screen.
